(19) United States
(12) Patent Application Publication
(10) Pub. No.: US 2016/0307697 A1
(43) Pub. Date: Oct. 20, 2016

(54) Magnet Manufacturing Method And Magnet

(71) Applicant: JTEKT CORPORATION, Osaka (JP)

(72) Inventors: Takumi MIO, Kariya-shi (JP); Koji NISHI, Anjo-shi (JP); Yusuke KIMOTO, Kariya-shi (JP); Takashi TAMURA, Itami-shi (JP)

(73) Assignee: JTEKT CORPORATION, Osaka (JP)

(21) Appl. No.: 15/094,373

(22) Filed: Apr. 8, 2016

(30) Foreign Application Priority Data
Apr. 16, 2015 (JP) 2015-084010

(51) Int. Cl. H01F 41/02; H01F 1/053; B22F 5/00; B22F 1/00; B22F 3/16; H01F 1/08; C22C 38/00

(52) U.S. Cl. CPC H01F 41/0266; H01F 1/08; H01F 1/053; C22C 38/005; C22C 38/001; B22F 1/0062; B22F 3/16; B22F 5/00; B22F 2301/355; B22F 2302/20; B22F 2998/10

(57) ABSTRACT

A magnet manufacturing method has a step of preparing mixed powder of magnetic powder of a hard magnetic material, which includes one or more of an Fe—N-based compound and an R—Fe—N-based compound and a lubricant that allows formation of an adsorption film on a surface of the magnetic powder, a step of heating the mixed powder at a temperature that is equal to or higher than a melting point of the lubricant and that is lower than a decomposition temperature of the magnetic powder to form the adsorption film of the lubricant on the surface of the magnetic powder, a step of pressurizing and molding the magnetic powder in order to obtain a primary molding, and a step of heating the primary molding at a temperature that is lower than the decomposition temperature of the magnetic powder.

### INCORPORATION BY REFERENCE

The disclosure of Japanese Patent Application No. 2015-084010 filed on Apr. 16, 2015 including the specification, drawings and abstract, is incorporated herein by reference in its entirety.

### BACKGROUND OF THE INVENTION

1. Field of the Invention

The invention relates to a magnet manufacturing method and a magnet.

2. Description of Related Art

Japanese Patent Application Publication No. 2007-39794 (JP 2007-39794 A) describes a magnet containing an Nd—Fe—B alloy or an Sm—Fe—N alloy. JP 2007-39794 further discloses that a soft magnetic metal is mixed with the above-described alloy and that the mixture is molded under pressure and sintered.

Japanese Patent Application Publication No. 2012-69962 (JP 2012-69962 A) discloses that an R—Fe—N—H-based magnetic material and soft magnetic powder are mixed together and that the mixture is compacted and solidified by impact compression using an underwater shock wave and that after the impact compression, a residual temperature is kept equal to or lower than a decomposition temperature of the magnetic material. This magnet contains no binder such as resin.

Japanese Patent Application Publication No. 2005-223263 (JP 2005-223263 A) discloses that a rare-earth permanent magnet is manufactured by forming an oxide film on Sm—Fe—N-based compound powder, then preliminarily compression-molding the Sm—Fe—N-based compound powder into a predetermined shape in a non-oxidizing atmosphere, and compacting the resultant compound at 350 to 500° C. in the non-oxidizing atmosphere. JP 2005-223263 discloses that the Sm—Fe—N-based magnet can thus be manufactured at a temperature lower than the decomposition temperature.

Japanese Patent Application Publication No. S62-206801 (JP S62-206801 A) discloses that a stearic acid is mixed with alloy powder to cover powder particles with the stearic acid and that the powder particles are then compression-molded and then sintered. The powder particles are covered with the stearic acid by mixing the powder with a toluene solution of the stearic acid to attach the toluene solution (stearic acid) to the surface of the powder.

Japanese Patent Application Publication No. 2015-8201 (JP 2015-8201 A) describes a magnetic manufacturing method including a pressurizing step of placing, in a mold, a lubricant and magnetic powder of a hard magnetic material resulting from molding of an R—Fe—N-based compound containing a rare earth element as R or an Fe—N-based compound and pressurizing the magnetic powder using the mold, while heating the magnetic powder and the lubricant at a first temperature that is lower than a decomposition temperature of the magnetic powder and that is equal to or higher than a melting point of the lubricant, to form a primary molding, and a firing step of heating the primary molding at a second temperature that is lower than the decomposition temperature of the magnetic powder to join surfaces of adjacent particles of the magnetic powder to form a second molding.

In JP 2007-39794 A and JP S62-206801 A, dysprosium (Dy), which is expensive and rare, needs to be used for the magnet containing the Nd—Fe—B alloy. When the Sm—Fe—N alloy is used, sintering is difficult due to the low decomposition temperature of the Sm—Fe—N alloy. The sintering involves temperatures equal to or higher than the decomposition temperature, leading to decomposition of the alloy to preclude the resultant magnet from demonstrating its performance as a magnet. Thus, Sm—Fe—N-based magnets are typically joined together with a bond such as resin. However, the use of the bond such as resin reduces the density of the magnet, causing a reduction in residual magnetic flux density.

In JP 2012-69962 A and JP 2005-223263 A, the magnetic particles are not sintered, and thus, gaps remain between particles of the powder in the molded magnet. In other words, the molded magnet of unsintered magnetic powder has lower density than the molded magnet of sintered magnetic powder. As a result, the molded magnet of the unsintered magnetic powder has lower residual magnetic flux density than that of the sintered magnetic powder.

In JP 2015-8201 A, the magnetic powder mixed with the lubricant is pressurized to form the primary molding. Thus, the lubricant promotes movement of the magnetic powder (reduces friction between the magnetic powder particles) to provide a primary molding with a high density. However, for magnets, there has been a demand to further enhance the residual magnetic flux density, and the enhancement of this characteristic is limited because a large amount of lubricant remains which does not contribute to magnetic characteristics.

### SUMMARY OF THE INVENTION

An object of the invention is to provide a magnet manufacturing method and a magnet that allow a high residual magnetic flux density to be obtained without the use of a bond.

A magnet manufacturing method according to an aspect of the invention has preparing mixed powder of magnetic powder of a hard magnetic material, which includes one or more of an Fe—N-based compound and an R—Fe—N-based compound (R: rare earth element) and a lubricant that allows formation of an adsorption film on a surface of the magnetic powder,

heating the mixed powder at a temperature that is equal to or higher than a melting point of the lubricant and that is lower than a decomposition temperature of the magnetic powder to form the adsorption film of the lubricant on the surface of the magnetic powder,

pressurizing and molding the magnetic powder in order to obtain a primary molding, and

heating the primary molding at a temperature that is lower than the decomposition temperature of the magnetic powder.

In the magnet manufacturing method according to this aspect, a compound that includes one or more of the Fe—N-based compound and the R—Fe—N-based compound is used as the magnetic powder of the hard magnetic material. Thus, a magnet can be inexpensively manufactured.

The mixed powder of the magnetic powder of the hard magnetic material and the lubricant is prepared and heated at the temperature that is equal to or higher than the melting point of the lubricant and that is lower than the decomposition temperature of the magnetic powder, to form the adsorption film of the lubricant on the surface of the magnetic powder. The adsorption film of the lubricant is thus formed on the surface of the magnetic powder. Consequently, in spite of the pressurization performed when the primary molding is subsequently obtained, the adsorption film of the lubricant remains due to sliding between particles of the magnetic powder. As a result, movement of the particles of the magnetic powder is promoted to provide a dense primary molding with reduced gaps. The primary molding is heated to join the surfaces of the particles of the magnetic powder to form a secondary molding. The secondary molding is configured such that the magnetic powder particles in the dense primary molding with filled gaps are joined together.

As described above, the manufacturing method according to this aspect allows a dense magnet with filled gaps to be manufactured.

In the manufacturing method in the above-described aspect, pressure molding of the primary molding is performed with no particles of the lubricant remaining. This indicates that concentrated presence of particles of the lubricant in the magnet is avoided. In other words, a dense magnet can be manufactured. Moreover, compared to a manufacturing method in which particles of the lubricant remain, the manufacturing method according to the above-described aspect reduces the amount of lubricant used.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a diagram illustrating steps of a magnetic manufacturing method according to a first embodiment;

FIG. 2 is a schematic diagram illustrating a mixing step for magnetic powder and a lubricant in the first embodiment;

FIG. 3 is a schematic diagram illustrating the mixing step for the magnetic powder and the lubricant in the first embodiment;

FIG. 4 is a diagram illustrating a relationship between a heating time and the density of a primary molding during generation of an adsorption film in the first embodiment;

FIG. 5 is a diagram illustrating a relationship between the heating time and a heating temperature during generation of an adsorption film in the first embodiment;

FIG. 6 is a diagram schematically depicting a configuration of a surface of magnetic powder on which an adsorption film has been generated, in the first embodiment;

FIG. 7 is a schematic diagram illustrating a pressurizing step for the magnetic powder and the lubricant in the first embodiment;

FIG. 8 is a schematic diagram illustrating the pressurizing step for the magnetic powder and the lubricant in the first embodiment;

FIG. 9 is an enlarged view schematically depicting a configuration of the primary molding in the first embodiment; and

FIG. 10 is a diagram illustrating changes in a heating temperature for a heat treatment step in first embodiment.

### DETAILED DESCRIPTION OF EMBODIMENTS

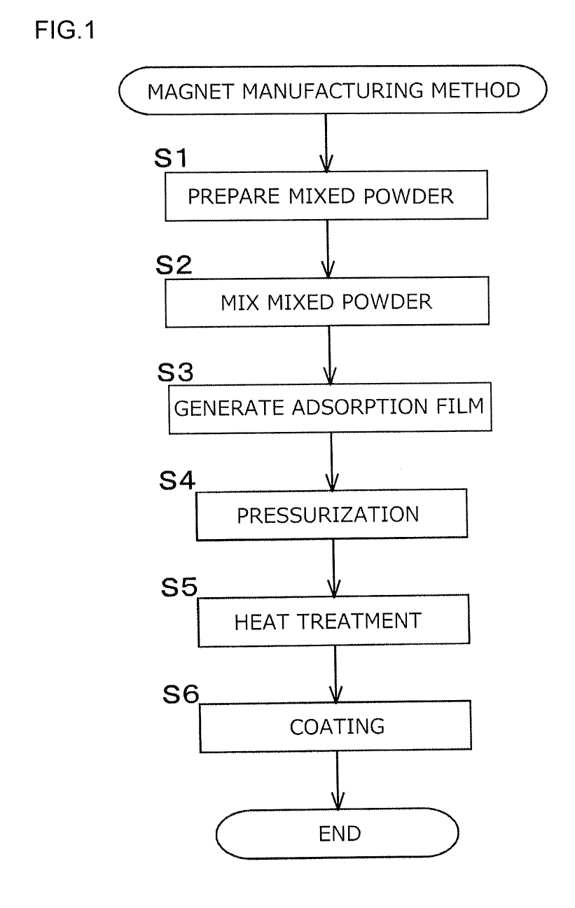

A magnet manufacturing method according to the invention will be described as an embodiment with reference to FIGS. 1 to 10. FIG. 1 is a diagram illustrating steps of the magnet manufacturing method of a first embodiment.

As illustrated in step S1 in FIG. 1, mixed powder is prepared which contains magnetic powder 1 of a hard magnetic material as a raw material for a magnet and a lubricant 2 that allows formation of an adsorption film on a surface of the magnetic powder 1.

As the magnetic powder 1, a compound is used which includes one or more of an Fe—N-based compound and an R—Fe—N-based compound. A rare earth element represented by R is preferably an element that is known as a so-called rare earth element and that is other than Dy. In particular, light rare earth elements are preferable, and among the light rare earth elements, Sm is suitable. The light rare earth elements described herein refer to elements included in lanthanoids and having a smaller atomic weight than Gd, that is, La, Ce, Pr, Nd, Pm, Sm, and Eu. A specific composition of the magnetic powder 1 is not limited as long as the magnetic powder 1 is an Fe—N-based compound or an R—Fe—N-based compound. Powder of Sm₂Fe₁₇N₃ or Fe₁₆N₂ is suitably used.

The magnetic powder 1 may be formed of powder with the same composition or may be formed by mixing powder with different compositions. Preferably, the magnetic powder 1 may be formed of powder with the same composition.

The magnetic powder 1 has an average particle size of approximately 2 μm to 5 μm. The use of a hard magnetic material that needs no Dy allows a magnet to be inexpensively manufactured. The magnetic powder 1 used does not have an oxide film formed all over the surface of the magnetic powder 1.

Metal soap powder (solid lubricant powder) is used as the lubricant 2. As the lubricant 2, powder of stearic acid-based metal such as zinc stearate is used. The lubricant 2 has an average particle size of approximately 10 μm. The lubricant 2 preferably has a larger average particle size than the magnetic powder 1. The lubricant 2 has a smaller specific gravity than the magnetic powder 1. Thus, setting a somewhat large initial size for the lubricant 2 enables each particle of the lubricant 2 to have a large mass. This prevents the lubricant 2 from being stirred up when the magnetic powder 1 is mixed with the lubricant 2 in step S2 described below.

A mixture ratio between the magnetic powder 1 and the lubricant 2 can be optionally set. The preferable mixture ratio between the magnetic powder 1 and the lubricant 2 is such that, in volume percentage, the magnetic powder is 80 to 90 vol %, whereas the lubricant 2 is 5 to 15 vol %. Besides the magnetic powder 1 and the lubricant 2, an additive may be added. Examples of the additive include organic solvents that disappear as a result of subsequent heating.

As illustrated in step S2 in FIG. 1, the magnetic powder 1 and the lubricant 2 prepared in the step S1 are mixed together while being ground.

The mixed powder of the magnetic powder 1 and the lubricant 2 may be obtained by mixing and simultaneously grinding the magnetic powder 1 and the lubricant 2.

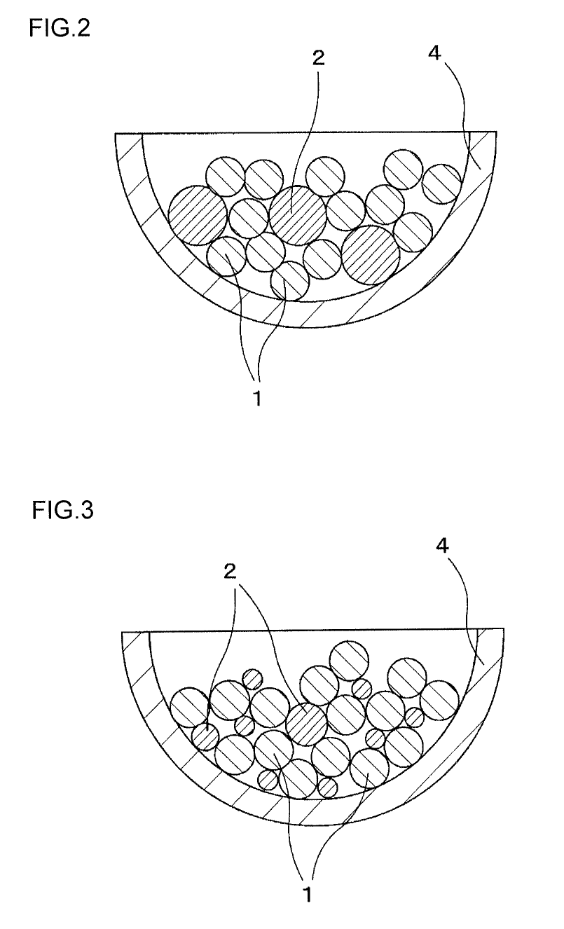

A method for forming the mixed powder is not limited. For example, in a mixture container 4, the magnetic powder 1 and the lubricant 2 are mixed together while being ground as depicted in FIG. 2. Mixing and simultaneously grinding the magnetic powder 1 and the lubricant 2 fractionizes the lubricant 2, which has a low joining strength, to reduce the general particle size of the lubricant 2, as depicted in FIG. 3. Thus, particles of the lubricant 2 present at the end of the mixing step have different particle sizes.

At the end of the mixing step, the mixed powder of the magnetic powder 1 and the lubricant 2 can contain reduced massive portions formed only of the magnetic powder 1 and have a reduced particle size of the lubricant 2. In other words, fine particles 2 of the lubricant can be present at positions proximate to each particle of the magnetic powder 1.

As illustrated in step S3 in FIG. 1, the mixed powder of the magnetic powder 1 and the lubricant 2 is heated to form an adsorption film 3 on the surface of the magnetic powder 1.

The mixed powder of the magnetic powder 1 and the lubricant 2 resulting from the mixture in the preceding step (step S2) is heated at a heating temperature T₁ to form the adsorption film 3 of the lubricant 2 on the surface of the magnetic powder 1. At this time, the heating temperature T₁ for the mixed powder of the magnetic powder 1 and the lubricant 2 is lower than a decomposition temperature T₂ of the magnetic powder 1 and is equal to or higher than a melting point T₃ of the lubricant 2 (T₃ T₁<T₂).

When the mixed powder of the magnetic powder 1 and the lubricant 2 is heated at the heating temperature T₁, the lubricant 2 is melted with the magnetic powder 1 not decomposed. The melted lubricant 2 flows along the surfaces of the particles of the magnetic powder 1 to cover the surface of the magnetic powder 1. Then, the adsorption film 3 is formed on the surface of the magnetic powder 1.

A heating time t at the heating temperature T₁ depends on the amount of heat applied to the mixed powder of the magnetic powder 1 and the lubricant 2 and is thus not limited to a given time. In other words, an elevated heating temperature T₁ increases the amount of heat applied to the mixed powder of the magnetic powder 1 and the lubricant 2 per unit time, enabling the heating time t to be shortened. When the heating temperature T₁ is relatively low, the heating time t is preferably extended.

In connection with the heating temperature T₁ and the heating time t, a larger amount of heat applied to the mixed powder of the magnetic powder 1 and the lubricant 2 allows more closely aggregated adsorption film 3 to be generated on the surface of the magnetic powder 1, preventing possible lubricant film shortage in a pressurizing step (step S4). A primary molding 5 and a magnet that have a high density can be manufactured.

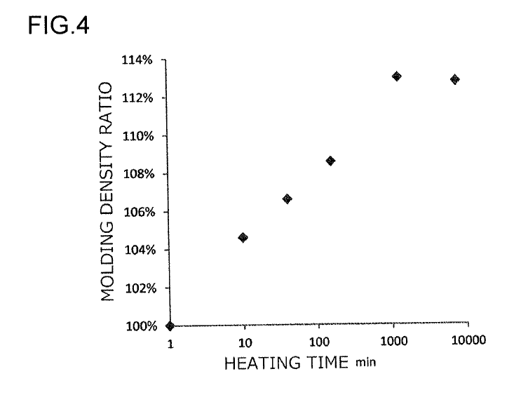

FIG. 4 illustrates a relationship between the heating time t and the density ratio of the primary molding 5 obtained specifically when a magnet was manufactured at a molding surface pressure of 1000 MPa by using a stearic acid as the lubricant 2 (melting point, T₃: 69.9° C.) and performing pressurization 20 times. The density ratio of the primary molding 5 is a value determined when the density of the primary molding 5 obtained at a heating temperature T₁ of 70° C. and at a heating time t of one minute is defined as 1.

As illustrated in FIG. 4, the density of the primary molding 5 increases with an increase in heating time t. In the form illustrated in FIG. 4, when the heating time t exceeds 1000 minutes, the density increase effect diminishes, indicating that this effect has been saturated.

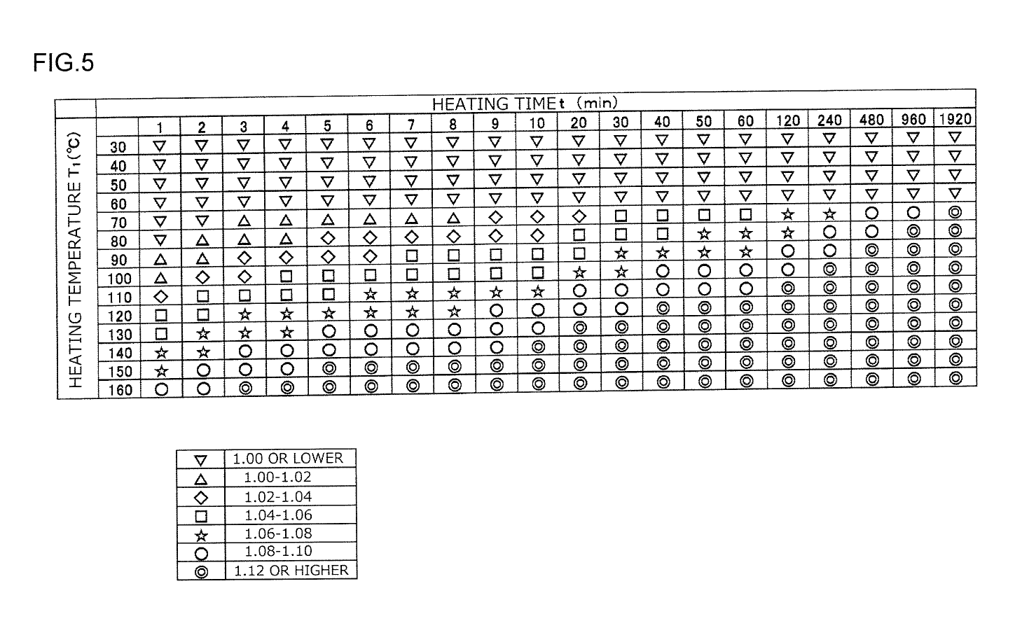

FIG. 5 illustrates the relationship between the heating temperature T₁ and the density ratio of the manufactured primary molding 5 which relationship is determined as in the case of FIG. 4. FIG. 5 is a matrix representing the relationship between the density ratio of the primary molding 5 and both the heating temperature T₁ and the heating time t.

As illustrated in FIG. 5, when the heating is performed at a temperature equal to or higher than the melting point T₃ of the lubricant 2, a molding with a higher density is obtained at a higher heating temperature T₁ and at a longer heating time t.

The heating time t and the molding density ratio in generation of the adsorption film 3 can be expressed by Expressions (1) and (2) described below. Based on Expression (1), the adsorption film 3 of the lubricant 2 enabling a desired molding density ratio to be achieved can be formed on the surface of the magnetic powder 1.

Expression (1) represents the relationship between the heating time t and the density ratio of the primary molding 5 within a range where the density increase effect is not saturated. This range is a region in FIG. 4 where the density of the primary molding 5 increases with an increase in the heating time t.

Specifically, Expression (1) represents the relationship between the heating time t and the density ratio of the primary molding 5 in a region in FIG. 4 having a shorter heating time t and a lower density ratio than an intersection point between a line (a line of a linear function) passing through any two points in a region where the density increase effect has not been saturated and a line (a line parallel to an x axis) passing through plot values at any two points in a region where the density increase effect has been saturated.

Molding density ratio=k×logₑ(correction time)+1 (1)

Correction time=the time when the heating temperature T₁ is held

$$\times 2 \hat{} \{ \frac{( {T}_{1} - {T}_{3} )}{10} \} \qquad ( 2 )$$

The correction time in Expression (1) is represented by Expression (2). In Expression (1), a density increase coefficient, that is, a coefficient varying depending on a particle size distribution and the type of the lubricant is denoted by k.

In accordance with Expressions (1) and (2), the heating time t allowing the primary molding 5 with a desired density to be obtained can be determined.

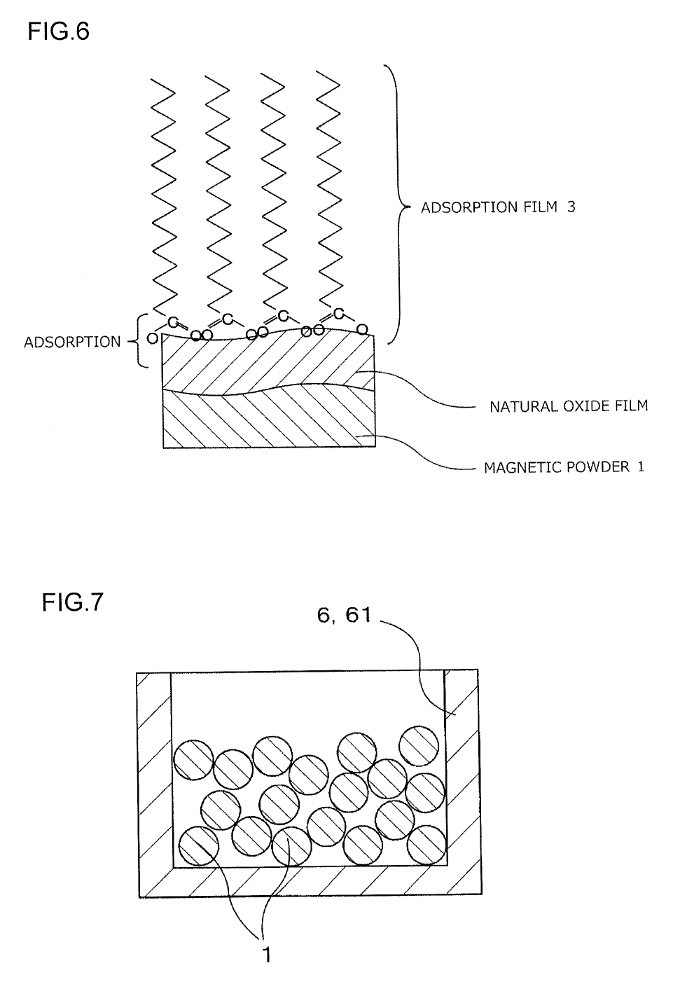

The adsorption film 3 generated on the surface of the magnetic powder 1 is adsorbed to the surface of the magnetic powder 1 without exposing the surface. This prevents possible shortage of a film of the lubricant 2. As depicted in FIG. 6, the adsorption film 3 is coupled to atoms of the magnetic powder 1 through interaction with the atoms and thus immobilized on the surface of the magnetic powder 1 without being detached from the surface.

The adsorption film 3 in the present embodiment is formed such that hydrocarbon chains in the lubricant 2 are closely aggregated as depicted in FIG. 6. The close aggregation of the hydrocarbon chains allows the adsorption film 3 to be formed without exposing the surface of the magnetic powder 1.

The adsorption film 3 reliably provides solid lubricity without causing lubricant film shortage. In the subsequent step (step S4), when pressurization is performed, the particles of the magnetic powder 1 move and are densely arranged, making the primary molding denser.

When the lubricant 2 does not form the adsorption film 3, the lubricant 2 is only interposed between the particles of the magnetic powder 1. In this case, sliding of the particles of the magnetic powder 1 results in lubricant film shortage. Lubricity is degraded to keep the density of the primary molding low.

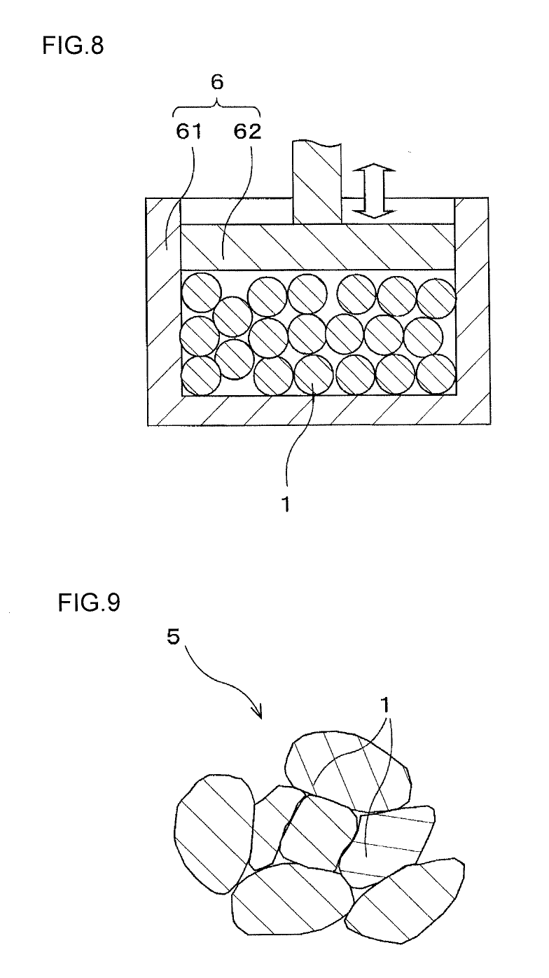

Subsequently, as illustrated in step S4 in FIG. 1, the magnetic powder 1 with the adsorption film 3 generated thereon is pressurized to form a primary molding 5 (FIG. 7 and FIG. 8).

In the pressurizing step, as depicted in a schematic diagram in FIG. 7, the magnetic powder 1 with the adsorption film 3 generated thereon is fed into a cavity in a pressurizing mold 6 (pressurizing lower mold 61 (mold)).

Subsequently, as depicted in a schematic diagram in FIG. 8, a pressurizing upper mold 62 (mold)) is assembled into the pressurizing lower mold 61 and moved in a direction in which the pressurizing upper mold 62 approaches the pressurizing lower mold 61. The magnetic powder 1 is thus pressurized by the pressurizing mold 6 (61 and 62). At this time, a pressure applied by the pressurizing mold 6 (61 and 62) is a pressure equal to or lower than a fracture pressure at which the magnetic powder 1 in the mixed powder of the magnetic powder 1 and the lubricant 2 is destroyed. In the present embodiment, the applied pressure is equal to or lower than 1 GPa.

Pressurization with the pressurizing mold 6 (61 and 62) is performed a plurality of times (twice or more). In other words, after a pressure is applied to the pressurizing upper mold 62, the pressure applied to the pressurizing upper mold 62 is weakened, and then, a pressure is applied to the pressurizing upper mold 62 again. Then, this operation is repeated. To weaken the pressure applied to the pressurizing upper mold 62, the pressurizing upper mold 62 may be moved upward or only the applied pressure may be reduced without upward movement of the pressurizing upper mold 62.

Pressurization with the pressurizing mold 6 (61 and 62) is performed a plurality of times, and an upper limit on the number of pressurizations may be the number of pressurizations resulting in saturation of the effect of an increase in the density of the primary molding 5. For example, the pressurization may be performed twice to thirty times.

Repetition of the pressurization allows formation of the primary molding 5 with progressively reduced gaps between the particles of the magnetic powder 1 as depicted in an enlarged view in FIG. 9. This is because a plurality of pressurizing operations allows rearrangement of the particles of the magnetic powder 1 arranged as a result of the last pressurization.

In the pressurizing mold 6, the adsorption film 3 of the lubricant 2 is interposed between abutting contact surfaces (sliding contact surfaces) of the adjacent particles of the magnetic powder 1 to allow the particles of the magnetic powder 1 to move smoothly. The gaps between the particles of the magnetic powder 1 in the primary molding 5 are reduced by synergetic action of rearrangement of the particles of the magnetic powder 1 and sliding of the particles of the magnetic powder 1 due to the adsorption film 3.

As illustrated in step S5 in FIG. 1, the primary molding 5 is heated in an oxidizing atmosphere to form a secondary molding (heat treatment step).

Heating the primary molding 5 in the oxidizing atmosphere causes exposed surfaces of the particles of the magnetic powder 1 to react with oxygen to generate an oxide film on the surface of each of the particles of the magnetic powder 1. The oxide film joins the surfaces of the adjacent particles of the magnetic powder 1. The oxide film is formed on a portion of each particle of the magnetic powder 1, which is exposed to the gap, while a base material with no oxide film formed thereon constitutes a portion of each particle of the magnetic powder 1, which is not exposed to the gap (the interface at which the particle of the magnetic powder 1 is compressed against the adjacent particle of the magnetic powder 1). Therefore, the oxide film is not formed all over the surface of each particle of the magnetic powder 1.

The secondary molding thus formed has a sufficient strength. This enables an increase in a flexural strength of the secondary molding. Moreover, in the pressurizing step, areas of the primary molding 5 where no magnetic powder 1 is present are reduced, enabling an increase in residual magnetic flux density of the secondary molding resulting from the heat treatment step. The secondary molding has a density of approximately 5 to 6 g/cm³.

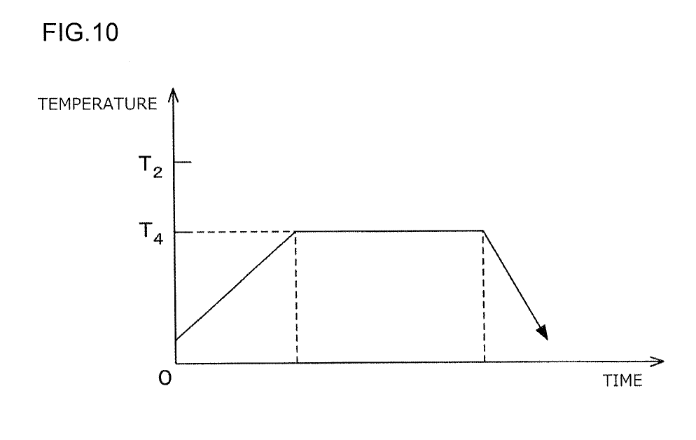

The heat treatment step is executed with the primary molding placed in a microwave heating furnace, an electric furnace, a plasma heating furnace, a high-frequency quenching furnace, a heating furnace with an infrared heater, or the like. The heating during the heat treatment step is not limited but may be performed so as to go through temperature changes depicted in FIG. 10.

As depicted in FIG. 10, a heating temperature T₄ is set lower than the decomposition temperature T₂ of the magnetic powder 1. For example, when Sm₂Fe₁₇N₃ or Fe₁₆N₂ is used as the magnetic powder 1, the heating temperature T₄ is set lower than 500° C. because the decomposition temperature T₂ of Sm₂Fe₁₇N₃ or Fe₁₆N₂ is approximately 500° C. For example, the heating temperature T₄ in the heat treatment step is approximately 200 to 300° C.

An oxygen concentration and an atmospheric pressure in the oxidizing atmosphere may be set to any values as long as the oxygen concentration and the atmospheric pressure allow the magnetic powder 1 to be oxidized. An oxygen concentration and an atmospheric pressure equal or close to the oxygen concentration and the atmospheric pressure in the air are sufficient for this purpose. Therefore, special management of the oxygen concentration and the atmospheric pressure is not needed. The heating may be performed in the aerial atmosphere. Setting the heating temperature T₄ at approximately 200 to 300° C. allows an oxide film to be formed regardless of whether the magnetic powder is Sm₂Fe₁₇N₃ or Fe₁₆N₂.

As illustrated in step S6 in FIG. 1, a treatment is executed in which the surface of the secondary molding formed in the heat treatment step is covered with a coating film, to form a tertiary molding.

Examples of the coating film for the tertiary molding include a plating film formed by electroplating of Cr, Zn, Ni, Ag, Cu, or the like, a plating film formed by electroless plating, a resin film formed by resin coating, a glass film formed by glass coating, and a film formed of Ti, diamond-like carbon (DLC), or the like. Examples of the electroless plating include electroless plating using Ni, Au, Ag, Cu, Sn, Co, or an alloy or a mixture thereof. Examples of the resin coating include coating with a silicone resin, a fluorine resin, a urethane resin, or the like.

The coating film formed on the tertiary molding functions like an egg shell. The tertiary molding can have an increased flexural strength as a result of a joining force exerted by the oxide film and the coating film. In particular, the electroless plating enables surface hardness and adhesion to be enhanced and allows the joining force of the magnetic powder 1 to be made stronger. Furthermore, for example, electroless nickel-phosphorous plating offers high corrosion resistance.

As described above, the oxide film joins the particles of the magnetic powder 1 together not only on the surface of the secondary molding but also inside the secondary molding. The joining force of the oxide film regulates free movement of the particles of the magnetic powder 1 inside the tertiary molding. This suppresses inversion of magnetic poles resulting from rotation of the magnetic powder 1. A high residual magnetic flux density can be achieved.

When the electroplating is applied in the coating step, the unplated secondary molding acts as an electrode. Thus, the secondary molding needs to have a high joining strength. However, when the electroless plating, the resin coating, or the glass coating is applied in the coating step, the joining strength of the secondary molding need not be so high as the joining strength needed for the secondary molding when the electroplating is applied. The joining force resulting from the oxide film is sufficient. Therefore, the coating step as described above allows the coating film to be reliably formed on the surface of the secondary molding.

When the electroless plating is applied in the coating step, the secondary molding is immersed in a plating solution. At this time, the plating solution acts to enter the inside of the secondary molding. However, the oxide film formed on the secondary molding effectively suppresses the entry of the plating solution. This is expected to inhibit possible corrosion of the secondary molding or the like resulting from the entry of the plating solution into the inside of the secondary molding.

In the manufacturing method of the present embodiment, a compound that includes one or more of an Fe—N-based compound and an R—Fe—N-based compound (R: rare earth element) is used as the magnetic powder 1 of the hard magnetic material. Thus, a magnet can be inexpensively manufactured.

Furthermore, the manufacturing method in the present embodiment allows avoidance of the use of dysprosium (Dy) as R. Therefore, a magnet can be inexpensively manufactured.

In the manufacturing method according to the present embodiment, the mixed powder of the magnetic powder 1 of the hard magnetic material and the lubricant 2 is prepared and heated at the temperature that is equal to or higher than the melting point T₃ of the lubricant 2 and that is lower than the decomposition temperature T₂ of the magnetic powder, to form the adsorption film 3 of the lubricant 2 on the surface of the magnetic powder 1. The adsorption film 3 of the lubricant 2 is thus formed on the surface of the magnetic powder 1. Consequently, even when pressurization is performed at a pressure equal to or lower than the fracture pressure in the subsequent step of obtaining the primary molding 5 (pressurizing step), the adsorption film 3 of the lubricant 2 remains instead of being peeled off, due to the sliding between the particles of the magnetic powder 1. As a result, movement of the particles of the magnetic powder 1 is promoted to provide a dense primary molding 5 with reduced gaps. The primary molding 5 is thermally treated to join the surfaces of the particles of the magnetic powder 1 together to form the secondary molding. That is, the secondary molding is configured such that the magnetic powder particles in the dense primary molding 5 with filled gaps are joined together.

As described above, the manufacturing method according to the present embodiment allows a dense magnet with filled gaps to be manufactured.

In the manufacturing method according to the present embodiment, pressure molding of the primary molding 5 is performed with no particles of the lubricant 2 remaining. This indicates that concentrated presence of particles of the lubricant in the magnet is avoided. In other words, a dense magnet can be manufactured. Moreover, compared to a manufacturing method in which particles of the lubricant 2 remain during the pressurizing step, the manufacturing method according to the present embodiment can reduce the amount of lubricant 2 used.

In the manufacturing method according to the present embodiment, a metal soap-based lubricant (stearic acid-based metal) is used as the lubricant 2. This lubricant is used and heated at the temperature T₁ to form the adsorption film 3 of the lubricant 2 on the surface of the magnetic powder 1.

In the manufacturing method according to the present embodiment, pressurization is performed a plurality of times during the pressurizing step (step S4). Performing pressurization twice or more times promotes movement of the particles of the magnetic powder 1, providing a dense primary molding 5 with filled gaps.

In the heat treatment step of heating the primary molding 5 (step S5) in the manufacturing method according to the present embodiment, the heating is performed at a temperature equal to or higher than the melting point T₃ of the lubricant 2. Consequently, the lubricant 2 is placed on the surfaces of the particles of the magnetic powder 1 contained in the primary molding 5.

A magnet manufactured in accordance with the present embodiment produces the above-described effects.

In step S4 (pressurizing step) in the above-described first embodiment, the magnetic powder 1 is pressurized at a pressure of 1 GPa, which is equal to or lower than the fracture pressure at which the magnetic powder 1 is destroyed. However, the magnetic powder 1 may be pressurized at a pressure of 1.5 GPa, which is equal to or higher than the fracture pressure at which the magnetic powder 1 is destroyed.

Even in this case, the adsorption film 3 of the lubricant 2 remains on the surface of the destroyed magnetic powder 1, promoting movement of the magnetic powder 1.

What is claimed is:

1. A magnet manufacturing method comprising:
preparing mixed powder of magnetic powder of a hard magnetic material, which includes one or more of an Fe—N-based compound and an R—Fe—N-based compound, and a lubricant that allows formation of an adsorption film on a surface of the magnetic powder;
heating the mixed powder at a temperature that is equal to or higher than a melting point of the lubricant and that is lower than a decomposition temperature of the magnetic powder to form the adsorption film of the lubricant on the surface of the magnetic powder;
pressurizing and molding the magnetic powder in order to obtain a primary molding; and
heating the primary molding at a temperature that is lower than the decomposition temperature of the magnetic powder.

2. The magnet manufacturing method according to claim 1, wherein
the lubricant is a metal soap-based lubricant.

3. The magnet manufacturing method according to claim 1, wherein
pressurization is performed a plurality of times.

4. The magnet manufacturing method according to claim 1, wherein
the heating of the primary molding is performed at a temperature equal to or higher than a melting point of the lubricant.

5. A magnet manufactured by the magnet manufacturing method according to claim 1.
